(19) United States
(12) Patent Application Publication
(10) Pub. No.: US 2026/0040091 A1
(43) Pub. Date: Feb. 5, 2026

(54) ON-DEMAND SCALING OF VIRTUAL CONTAINERS IN WIRELESS O-RAN CLOUD NETWORK

(71) Applicant: DISH Wireless L.L.C., Englewood, CO (US)

(72) Inventor: Manish Uniyal, Parker, CO (US)

(21) Appl. No.: 18/789,649

(22) Filed: Jul. 30, 2024

(51) Int. Cl. H04W 24/02; G06F 9/50; H04W 28/16; H04W 88/08

(52) U.S. Cl. CPC H04W 24/02; G06F 9/5077; H04W 28/16; H04W 88/085

(57) ABSTRACT

An apparatus comprises a memory and a processor communicatively coupled to one another. The processor is configured to determine a network resource demand in the communication network. The network resource demand comprises multiple resource assignments in the communication network. Further, the processor is configured to determine whether the network resource demand meets a usage threshold, generate a trigger requesting rescaling of one or more virtual containers in a containerized environment associated with the communication network in response to determining that the network resource demand meets the usage threshold, and generate multiple possible modifications based on the trigger. The possible modifications comprise one or more changes to network resource utilization in the communication network. The processor is configured to rescale the one or more virtual containers in the containerized environment in accordance with the possible modifications.

### TECHNICAL FIELD

The present disclosure relates generally to scaling operations performed in a communication network, and more specifically to a system and method configured to perform on-demand scaling of virtual containers in the communication network.

### BACKGROUND

Communication systems comprise a finite number of resources available to perform daily communication operations. The output demands of the communication systems may increase as traffic is increased in specific areas of a communication network. As the output demands of the communication systems increase, these systems may be configured to power down to allow for additional resources to be allocated to perform additional communication operations. In cases where the communication systems are powered down or offline, communication operations are disrupted and exchanges of data may not be completed in the communication network.

### SUMMARY OF THE DISCLOSURE

In one or more embodiments, systems and methods disclosed herein are configured to perform one or more on-demand scaling operations. The systems and methods may be configured to achieve optimal (e.g., target) performance and cost with centralized unit (CU) and distributed unit (DU) auto-scaling in a wireless open-radio access network (O-RAN) cloud network. The virtual containers may be one or more deployable units of a system comprising one or more processing resources and one or more memory resources. The virtual containers may be configured to perform one or more operations in an O-RAN communication network. The virtual containers are configured to share some or all the processing resources and the memory resources among each other. Each of the virtual containers may be configured in accordance with one or more access commands to perform one or more communication operations in a wireless O-RAN communication network (e.g., a communication network). In some embodiments, the virtual containers may be deployed in one or more containerized environments. In some embodiments, the systems are configured to modify the virtual containers in one or more containerized environments dynamically based on current demands of the communication network. The systems may be configured to scale and/or rescale the virtual containers to match resource demands from the communication network in real-time. Herein, real-time may refer to near instant (e.g., within one or more seconds or less) operations performed in short proximity to one another. The systems may be configured to scale and/or rescale the virtual containers in accordance with current resource demands in the communication network based on one or more alarm inputs and/or one or more tracked indicators.

In one or more embodiments, the systems are configured to scale (and/or rescale) the virtual containers vertically and/or horizontally. The virtual containers may be scaled out horizontally by adding new virtual containers in a given containerized environment. The virtual containers may be scaled in horizontally by removing existing virtual containers in a given containerized environment. The virtual containers may be scaled up vertically by adding new processing resources and/or memory resources in one or more virtual containers in a given containerized environment. The virtual containers may be scaled down vertically by removing existing processing resources and/or memory resources in one or more virtual containers in a given containerized environment.

In one or more embodiments, the systems and methods described herein are integrated into a practical application to scale (and/or rescale) virtual containers in a containerized environment in accordance with current network demands. In particular, the systems and methods are integrated into practical applications of: (1) monitoring demands of network resources in a communication site at any point in time; (2) regulating, modifying, and/or controlling network resources provided at each virtual container in a containerized environment comprising multiple virtual containers; (3) distribute network resources among virtual containers in one or more containerized environments to perform one or more operations based on one or more alarm inputs generated in accordance with one or more tracked indicators; and (4) regulating, modifying, and/or controlling network resources allocated in the communication network. The systems and methods may be configured to provide a deep understanding of network resources consumed at any containerized environments within a given communication site. At a given point in time, the systems and methods may be configured to trigger replacement of any number of specific virtual containers if network resource consumption at a given virtual container is determined to at least partially match one or more alarm inputs and/or one or more tracked indicators.

In addition, the systems and methods described herein are integrated into a technical advantage of increasing processing speeds in a computer system, because processors associated with the systems are configured to control consumption of network resources in a containerized environment to be within a predefined threshold. In some embodiments, the systems and methods are configured to increase allocation efficiency of processing resources and memory resources at the containerized environments by actively determining resource demands in specific communication sites and modifying system configuration to change a number of network resources assigned in virtual containers throughout a communication network. Further, the systems and methods are integrated into a technical advantage of improving usage of existing containerized environments in the communication network comprising multiple virtual containers by meeting resource demands at one or more virtual containers. In this regard, the systems and methods are configured to perform one or more scaling operations that inhibit, prevent, and/or reduce reliance on existing container configurations by reassigning network resources in virtual containers configured to perform specific communication operations in the communication network.

In one or more embodiments, the systems and methods may be performed by an apparatus, such as a server communicatively coupled to multiple network components in a core network, one or more base stations in a radio access network, and one or more user equipment. Further, the systems may be a wireless communication system, which comprises the apparatus. In addition, the systems may be performed as part of a process performed by the apparatus communicatively coupled to the network components in the core network. As a non-limiting example, the apparatus may comprise a memory and a processor communicatively coupled to one another. The memory may be operable to store one or more usage thresholds associated with demand usage in a communication network. The processor may be configured to determine a network resource demand in the communication network. The network resource demand may comprise multiple resource assignments in the communication network. Further, the processor may be configured to determine whether the network resource demand meets a usage threshold, generate a trigger requesting rescaling of one or more virtual containers in a containerized environment associated with the communication network in response to determining that the network resource demand meets the usage threshold, and generate multiple possible modifications based on the trigger. The possible modifications may comprise one or more changes to network resource utilization in the communication network. The processor may be configured to rescale the one or more virtual containers in the containerized environment in accordance with the possible modifications.

Certain embodiments of this disclosure may comprise some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system, in accordance with one or more embodiments;

FIG. 2 illustrates a system architecture, in accordance with one or more embodiments; and

FIG. 3 illustrates an example flowchart of a method to perform one or more scaling operations, in accordance with one or more embodiments.

### EXAMPLE EMBODIMENTS

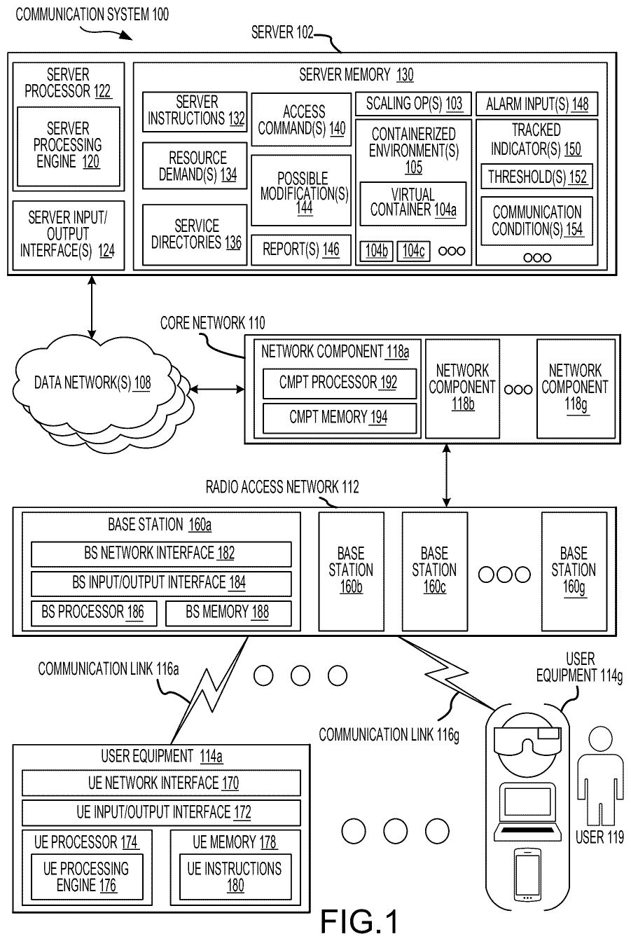

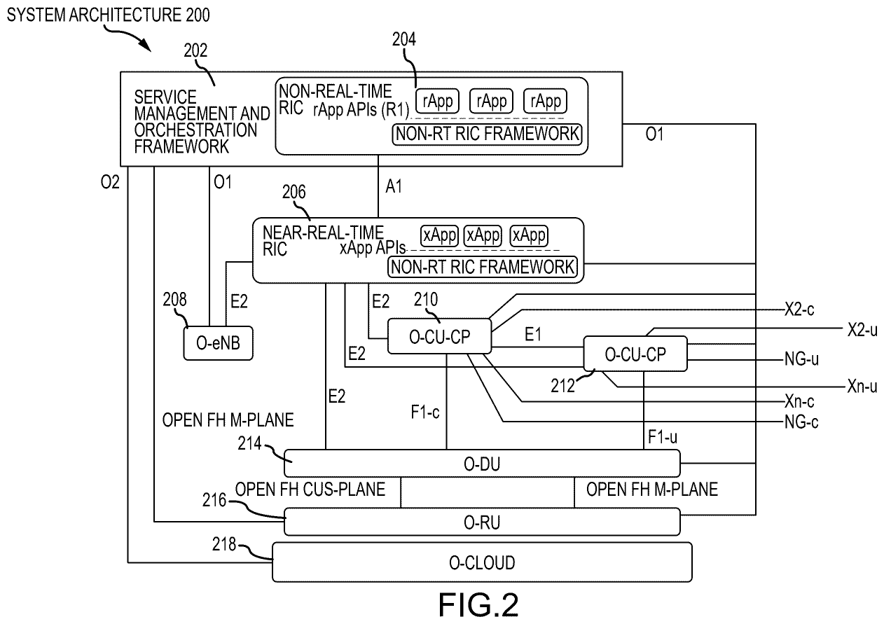

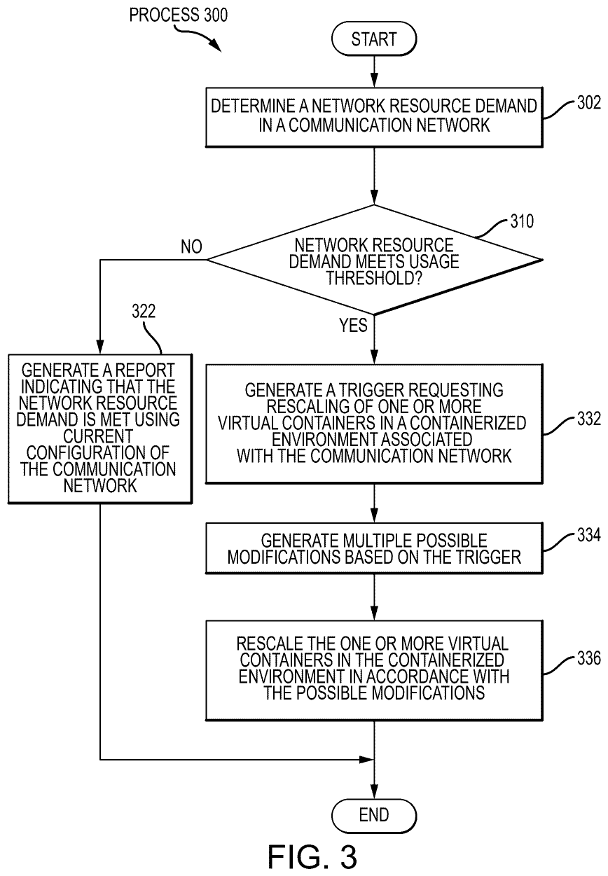

In one or more embodiments, systems and methods described herein are configured to perform one or more scaling operations. In one or more embodiments, FIG. 1 illustrates a communication system 100 in which a server 102 is configured to perform one or more scaling operations 103. FIG. 2 illustrates a system architecture 200 for open-radio access network (O-RAN) communication network in which the communication system 100 of FIG. 1 is configured to communicate with one or more communication sites. FIG. 3 illustrates a process 300 to dynamically scale virtual containers 104 in at least one containerized environment 105.

### Communication System Overview

FIG. 1 illustrates a diagram of a communication system 100 (e.g., a wireless communication system) that comprises a server 102 configured to perform one or more scaling operations 103 in a communication network (e.g., in a wireless O-RAN communication network), in accordance with one or more embodiments. In the communication system 100 of FIG. 1, the server 102 may be the communication terminal communicatively coupled to one or more data networks 108, a core network 110, and a radio access network (RAN) 112. In FIG. 1, the server 102 is communicatively coupled to multiple user equipment 114a-114g (collectively, user equipment 114) via the RAN 112 via multiple corresponding communication links 116a-116g (collectively, communication links 116) established between each user equipment 114 and the RAN 112. As represented by a user equipment 114a, the user equipment 114 may be operated or attended by one or more users 117. In the example of FIG. 1, the server 102 may be communicatively coupled to multiple additional devices in the communication system 100. While FIG. 1 shows the server 102 connected directly to the one or more data networks 108, the server 102 may be located inside the core network 110 as part of one or more of the network components (e.g., any of the network components 118a-118g) in the core network 110.

In one or more embodiments, the communication system 100 comprises the user equipment 114, the RAN 112, the core network 110, the one or more data networks 108, and the server 102. In come embodiments, the communication system 100 may comprise a Fifth Generation (5G) mobile network or wireless communication system, utilizing high frequency bands (e.g., 24 Gigahertz (GHz), 39 GHz, and the like) or lower frequency bands such (e.g., Sub 6 GHz). In this regard, the communication system 100 may comprise a large number of antennas. In some embodiments, the communication system may perform one or more operations associated with the 5G New Radio (NR) protocols described in reference to the Third Generation Partnership Project (3GPP). As part of the 5G NR protocols, the communication system 100 may perform one or more millimeter (mm) wave technology operations to improve bandwidth or latency in wireless communications.

In some embodiments, the communication system 100 may be configured to partially or completely enable communications via one or more various radio access technologies (RATs), wireless communication technologies, or telecommunication standards, such as Global System for Mobiles (GSM) (e.g., Second Generation (2G) mobile networks), Universal Mobile Telecommunications System (UMTS) (e.g., Third Generation (3G) mobile networks), Long Term Evolution (LTE) of mobile networks, LTE-Advanced (LTE-A) mobile networks, 5G NR mobile networks, or Sixth Generation (6G) mobile networks.

### Communication System Components

### Server

The server 102 is generally any device or apparatus that is configured to process data, communicate with the data networks 108, one or more network components 118a-118g (collectively, network components 118) in the core network 110, the RAN 112, and the user equipment 114. The server 102 may be configured to monitor, track data, control routing of signal, and control operations of certain electronic components in the communication system 100, associated databases, associated systems, and the like, via one or more interfaces. The server 102 is generally configured to oversee operations of a server processing engine 120. The operations of the server processing engine 120 are described further below. In some embodiments, the server 102 comprises a server processor 122, one or more server Input (I)/Output (O) interfaces 124, and a server memory 130 communicatively coupled to one another. The server 102 may be configured as shown, or in any other configuration. As described above, the server 102 may be located in one of the network components 118 located in the core network 110 and may be configured to perform one or more network functions (NFs).

The server processor 122 may comprise one or more processors operably coupled to and in signal communication with the one or more server I/O interfaces 124, and the server memory 130. The server processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 122 may be a programmable logic device, a microcontroller, a microprocessor, or any suitable combination of the preceding. The one or more processors in the server processor 122 are configured to process data and may be implemented in hardware or software executed by hardware. For example, the server processor 122 may be an 8-bit, a 16-bit, a 32-bit, a 64-bit, or any other suitable architecture. The server processor 122 may comprise an arithmetic logic unit (ALU) to perform arithmetic and logic operations, processor registers that supply operands to the ALU, and store the results of ALU operations, and a control unit that fetches software instructions such as server instructions 132 from the server memory 130 and executes the server instructions 132 by directing the coordinated operations of the ALU, registers and other components via the server processing engine 120. The server processor 122 may be configured to execute various instructions. For example, the server processor 122 may be configured to execute the server instructions 132 to perform functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

In one or more embodiments, the server I/O interfaces 124 may be hardware configured to perform one or more communication operations 302-336 described in process 300 in reference to FIG. 3. The server I/O interfaces 124 may comprise one or more antennas as part of a transceiver, a receiver, or a transmitter for communicating using one or more wireless communication protocols or technologies. In some embodiments, the server I/O interfaces 124 may be configured to communicate using, for example, NR or LTE using at least some shared radio components. In other embodiments, the server I/O interfaces 124 may be configured to communicate using single or shared radio frequency (RF) bands. The RF bands may be coupled to a single antenna, or may be coupled to multiple antennas (e.g., for a multiple-input multiple output (MIMO) configuration) to perform wireless communications. The server I/O interfaces 124 may be configured to comprise one or more peripherals such as a network interface, one or more administrator interfaces, and one or more displays.

The server network interfaces that may be part of the server I/O interfaces 124 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the user equipment 114, the Internet, an Intranet, a private network, a public network, a peer-to-peer network, the public switched telephone network, a cellular network, a local area network (LAN), a metropolitan area network (MAN), a wide area network (WAN), and a satellite network. The server network interface may be configured to support any suitable type of communication protocol.

The one or more administrator interfaces that may be part of the server I/O interfaces 124 may be user interfaces configured to provide access and control to of the server 102 to one or more users (e.g., the user 119) or electronic devices. The one or more users may access the server memory 130 upon confirming one or more access credentials to demonstrate that access or control to the server 102 may be modified. In some embodiments, the one or more administrator interfaces may be configured to provide hardware and software resources to the one or more users. Examples of user devices comprise, but are not limited to, a laptop, a computer, a smartphone, a tablet, a smart device, an Internet-of-Things (IoT) device, a simulated reality device, an augmented reality device, or any other suitable type of device. The administrator interfaces may enable access to one or more graphical user interfaces (GUIs) via an image generator display (e.g., one or more displays), a touchscreen, a touchpad, multiple keys, multiple buttons, a mouse, or any other suitable type of hardware that allow users to view data or to provide inputs into the server 102. The server 102 may be configured to allow users to send requests to one or more user equipment 114.

In the example of FIG. 1, the one or more displays that may be part of the server I/O interfaces 124 may be configured to display a two-dimensional (2D) or three-dimensional (3D) representation of a service. Examples of the representations may comprise, but are not limited to, a graphical or simulated representation of an application, diagram, tables, or any other suitable type of data information or representation. In some embodiments, the one or more displays may be configured to present visual information to one or more users (not shown). The one or more displays may be configured to present visual information to the one or more users updated in real-time. The one or more displays may be a wearable optical display (e.g., glasses or a head-mounted display (HMD)) configured to reflect projected images and enable user to see through the one or more displays. For example, the one or more displays may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the one or more displays are a graphical display on the server 102. For example, the graphical display may be a tablet display or a smartphone display configured to display the data representations.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 is operable to store the server instructions 132, one or more resource demands 134, one or more service directories 136, one or more access commands 140, one or more possible modifications 144, one or more reports 146, the one or more scaling operations 103, the one or more containerized environments 105 comprising one or more virtual containers 104 (e.g., virtual container 104a, virtual container 104b, and virtual container 104c among others), one or more alarm inputs 148, and one or more tracked indicators 150 comprising one or more thresholds 152 and one or more communication conditions 154 among others. In the server memory 130, the server instructions 132 may comprise commands and controls for operating one or more specific NFs in the core network 110 when executed by the server processing engine 120 of the server processor 122.

In one or more embodiments, the instructions 132 are configured to instruct one or more network components 118 in the core network 110 to establish one or more configuration scripts to perform one or more scaling operations 103 and/or additional operations. The one or more configuration scripts may be configured to enable automation of routing and/or configuration of network components 118 in the core network 110. In this regard, the one or more configuration scripts may reconfigure multiple cloud-NFs (CNFs) that establish initial communication sessions with at least one network repository function (NRF) in a communication path comprising one or more additional network components 118. In this regard, the one or more configuration scripts may be configured to instruct routing and/or configuration of communication procedures based on static routing commands to restore services (e.g., applications) in the core network 110.

The one or more resource demands 134 may be communications or messages configured to indicate requests for access of an application (via an API) or a service. The one or more resource demands 134 may be communications and/or messages requesting access to specific network resources in a network slice in accordance with a corresponding priority level. Further, the one or more resource demands 134 may be requests for reallocation of one or more network resources to provide one or more connectivity allowances (e.g., access) between the server 102, the user equipment 114, the base stations 160, and one or more of the network components 118. The one or more resource demands 134 may be requested for specific departments and/or tenants. The one or more resource demands 134 may be predefined or dynamically defined in accordance with one or more rules and policies.

The one or more service directories 136 may be configured to store service-specific information and/or user-specific information. The service directories 136 may enable the server 102 to confirm user credentials to access one or more network components (e.g., one of the network components 118 configured to perform one or more NFs in the core network 110). The service directories 136 may be configured to store provider-specific information. The service directories 136 may enable the server 102 to validate credentials associated with a specific provider (e.g., one of the CNFs) against corresponding user-specific information in the service directories 136. The service directories 136 may be configured to store one or more tenant profiles 138 and a reference to one or more services. The service directories 136 may be configured to store provider-specific information and service-specific information. The provider-specific information may enable the server 102 to validate credentials associated with a specific provider (e.g., one of the NFs) against corresponding user-specific information and service-specific information.

In one or more embodiments, the one or more access commands 140 are configured to establish one or more communication sessions between two or more network components 118 in the core network 110. The access commands 140 may be configured to establish one or more communication sessions between one or more network components 118 in the core network 110 and one of the user equipment 114. Each configuration command of the access commands 140 may establish a communication session between a first network component of the network components 118 comprising the server 102 and a second network component of the network components 118 based at least in part upon a first configuration command of the access commands 140. The access commands 140 may be routing and configuration information for reinstating or reestablishing communication sessions when a change is detected in the operations of the core network 110. For example, in response to losing a specific communication session established with the first access command, the server 102 may attempt to reinstate the specific communication session based at least in part upon a second access command. The access commands 140 may be dynamically or periodically updated from another of the network components 118 in the core network 110. Herein, communication sessions refer to communication signals exchanged between the server 102 and additional network components 118 in the core network 110. In some embodiments, the access commands 140 are provided to the server 102 from another of the network components 118 performing a specific NF. The access commands 140 may be configured to enable access of the one or more services. The access commands 140 may be configured to enable access of one or more name-spaces (not shown) and/or one or more slice groups (not shown) in a given containerized cluster.

In one or more embodiments, the scaling operations 103 are one or more operations performed to inhibit, reduce, and/or prevent loss and/or waste of network resources in the communication system 100. Further, the scaling operations 103 are one or more operations to regulate and/or control processing consumption, memory consumption, and/or power consumption. The scaling operations 103 may be configured to provide control information to perform one or more operations based at least in part upon analyzed data from one or more communication operations. The scaling operations 103 may be routing and configuration information for establishing, reinstating, and/or reestablishing communication sessions between the server 102 and one or more network components 118, one or more base stations 160, and/or one or more user equipment 114. The scaling operations 103 may be dynamically or periodically updated based on one or more rules and policies.

In one or more embodiments, the one or more scaling operations 103 may be configured to dynamically scale and/or rescale virtual containers in one or more containerized environments 105. The virtual containers 104 may be one or more deployable units of a system comprising one or more processing resource, one or more memory resources, and/or one or more power resources. The virtual containers 104 are configured to share some or all the processing resources and the memory resources among each other. Each of the virtual containers 104 may be configured in accordance with one or more access commands 140 to aid in performing one or more communication operations in a communication network. In some embodiments, the virtual containers 104 may be deployed in one or more containerized environments 105. In some embodiments, the one or more scaling operations 103 are configured to modify the virtual containers 104 in one or more containerized environments 105 dynamically based on current demands of the communication network. The one or more scaling operations 103 may be configured to scale and/or rescale the virtual containers 104 to meet the resource demands 134 in real-time. Herein, real-time may refer to near instant (e.g., within one or more seconds or less) operations performed in short proximity to one another. The one or more scaling operations 103 may be configured to preemptively scale and/or rescale the virtual containers 104 in accordance with expected demands over a specific time duration. In other embodiments, the one or more scaling operations 103 may be configured to determine whether the one or more resource demands 134 meet one or more specific tracked indicators 150. If the one or more specific tracked indicators 150 are met, the scaling operations 103 may comprise triggering rescaling and/or scaling of the virtual containers 104. In this regard, the scaling operations 103 may comprise generating one or more possible modifications 144 comprising suggestions to modify a current network resource utilization. If the one or more specific tracked indicators 150 are not met, the scaling operations 103 may comprise maintaining a current and/or predefined network resource utilization in the virtual containers 104.

In one or more embodiments, the one or more scaling operations 103 are configured to dynamically scale (and/or rescale) the virtual containers 104 vertically and/or horizontally. The virtual containers 104 may be scaled out horizontally by adding new virtual containers 104 in a given containerized environment 105. The virtual containers 104 may be scaled in horizontally by removing existing virtual containers 104 in a given containerized environment 105. The virtual containers 104 may be scaled up vertically by adding new processing resources and/or memory resources in one or more virtual containers 104 in a given containerized environment 105. The virtual containers 104 may be scaled down vertically by removing existing processing resources and/or memory resources in one or more virtual containers 104 in a given containerized environment 105. In one or more embodiments, the systems may be configured to dynamically scale the virtual containers 104 vertically and horizontally at a same time, simultaneously, in conjunction with one another, and/or within a period of time. The one or more scaling operations 103 may be one or more on-demand scaling operations for one or more virtual containers 104 in wireless O-RAN cloud networks.

The one or more containerized environments 105 may be one or more virtual spaces in which one or more virtual containers 104 may be deployed to enable operations of one or more communication operations in the communication system 100. The virtual containers 104 may be one or more pods configured to be deployed in a containerized environment (e.g., Kubernetes environment). The one or more virtual containers 104 may comprise network resources that are co-located and co-scheduled. The virtual containers 104 may be configured as redundancies of one another or as standalone portions of a wireless communication network. Herein, the systems and methods may be configured to dynamically assign the network resources during maintenance windows. Further, the systems and methods may be configured to dynamically assign the network resources outside of maintenance window.

The possible modifications 144 may be recommendations presented to the server 102 comprising suggestions to modify a number of network resources assigned to perform and/or facilitate communication operations at the network components 118, the base stations 160, and/or the user equipment 114 based on the alarm inputs 148 and/or the one or more tracked indicators 150. The possible modifications 144 may comprise one or more dynamic suggestions to modify the one or more access commands 140. In one or more embodiments, the dynamic suggestions are the one or more scaling operations 103 configured to control and/or modify operations of the server 102. The scaling operations 103 may be configured to dynamically provide control information to perform one or more of the operations based at least in part upon the alarm inputs 148 and/or the one or more tracked indicators 150. In one or more embodiments, the possible modifications 144 may be configuration elements configured to associate a portion of the communication spectrum with one or more service releases. The possible modifications 144 may be configured to provide one or more suggestions to modify (e.g., add, maintain, and/or remove) entire virtual containers 104 comprising the network resources in a given communication site and/or to modify network resource utilization in the communication network. The possible modifications 144 may be suggestions configured to be performed immediately (e.g., within a short period of time, such as a couple of seconds or less), over a period of time (e.g., periodically over a period of time), and/or at a scheduled time (e.g., at a later time).

The one or more reports 146 may be communications or messages configured to indicate information to one or more of the network components 118, the base stations 160, and/or the user equipment 114.

The one or more alarm inputs 148 may be one or more triggering commands configured to inform the server 102 on whether one or more configuration commands are met within a predefined time duration. The alarm inputs 148 may be one or more triggers configured to initiate one or more scaling operations 103. In some embodiments, the alarm inputs 148 may be predefined and/or dynamically generated over time based on one or more resource demands 134. The one or more alarm inputs 148 may be generated by the server 102 and/or one or more of the network components 118. The alarm inputs 148

The tracked indicators 150 may comprise some, many, or several indicators. The tracked indicators 150 may comprise one or more thresholds 152 and one or more communication conditions 154 among others. The tracked indicators 150 may be representative of one or more changes in the network resource utilization of the communication system 100. The network resource utilization may comprise information relating to one or more network resources used in the communication system 100. The network resource may be power resources, memory resources, and/or processing resources that are consumed in the communication system 100 to communicate in one or more data networks 110 using a communication spectrum. The network resources may be power resources and/or frequency resources in the communication spectrum used as a basis to perform one or more communication operations in one or more communication sites. The one or more communication conditions 154 may be one or more configuration parameters configured to provide guidelines and/or information to inform the analyses performed by the server processor 122. The communication conditions 154 may be updated periodically over time. The communication conditions 154 may be updated dynamically over time. The communication conditions 154 may be guidelines to analyze current network resource utilization and/or the one or more resource demands 134. In one or more embodiments, the thresholds 152 may be one or more specific numbers and/or number ranges associated with a specific parameter and/or indicator. The thresholds 152 may be a specific value representing a higher boundary or a lower boundary. The thresholds 152 may be one or more threshold ranges comprising higher boundaries and lower boundaries. The thresholds 152 may be a percentage value representing a similarity and/or a difference between the network resource utilization requested in the resource demands 134 and a current network resource utilization. The thresholds 152 may be determined based on information associated with the communication operations. The thresholds 152 may be determined dynamically over time. The thresholds 152 may be predefined and/or predetermined in accordance with information in activity associated with one or more of the communication operations. In some embodiments, the server 102 may be configured to calculate the thresholds 152 based on information obtained via the server I/O interfaces 124 and/or UE network interfaces 170.

### User Equipment

In one or more embodiments, each of the user equipment 114 (e.g., the user equipment 114a and a user equipment 114g representative of the user equipment 114a-114g) may be any computing device configured to communicate with other devices, such as the server 102, other network components 118 in the core network 110, databases, and the like in the communication system 100. Each of the user equipment 114 may be configured to perform specific functions described herein and interact with one or more network components 118 in the core network 110 via one or more base stations 160. Examples of user equipment 114 comprise, but are not limited to, a laptop, a computer, a smartphone, a tablet, a smart device, an IoT device, a simulated reality device, an augmented reality device, or any other suitable type of device.

In one or more embodiments, referring to the user equipment 114a as a non-limiting example of the user equipment 114, the user equipment 114a may comprise a user equipment (UE) network interface 170, a UE I/O interface 172, a UE processor 174 configured to execute a UE processing engine 176, and a UE memory 178 comprising one or more UE instructions 180. The UE network interface 170 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the Internet, an Intranet, a private network, a public network, a peer-to-peer network, the public switched telephone network, a cellular network, a local area network (LAN), a metropolitan area network (MAN), a wide area network (WAN), and a satellite network. The UE network interface 170 may be configured to support any suitable type of communication protocol.

The UE I/O interface 172 may be hardware configured to perform one or more communication operations 302-336 described in process 300 in reference to FIG. 3. The UE I/O interface 172 may comprise one or more antennas as part of a transceiver, a receiver, or a transmitter for communicating using one or more wireless communication protocols or technologies. In some embodiments, the UE I/O interface 172 may be configured to communicate using, for example, 5G NR or LTE using at least some shared radio components. In other embodiments, the UE I/O interface 172 may be configured to communicate using single or shared RF bands. The RF bands may be coupled to a single antenna, or may be coupled to multiple antennas (e.g., for a MIMO configuration) to perform wireless communications. In some embodiments, the user equipment 114a may comprise capabilities for voice communication, mobile broadband services (e.g., video streaming, navigation, and the like), or other types of applications. In this regard, the UE I/O interface 172 of the user equipment 114a may communicate using machine-to-machine (M2M) communication, such as machine-type communication (MTC), or another type of M2M communication.

In some embodiments, the user equipment 114a is communicatively coupled to one or more of the base stations 160 via one or more communication links 116 (e.g., the communication link 116a and the communication link 116g representative of the communication links 116). The user equipment 114a may be a device with cellular communication capability such as a mobile phone, a hand-held device, a computer, a laptop, a tablet, a smart watch or other wearable device, or virtually any type of wireless device. In some applications, the user equipment 114 may be referred to as a UE, UE device, or terminal.

The UE processor 174 may comprise one or more processors operably coupled to and in signal communication with the UE network interface 170, the UE I/O interface 172, and the UE memory 178. The UE processor 174 is any electronic circuitry, including, but not limited to, state machines, one or more CPU chips, logic units, cores (e.g., a multi-core processor), FPGAs, ASICs, or DSPs. The UE processor 174 may be a programmable logic device, a microcontroller, a microprocessor, or any suitable combination of the preceding. The one or more processors in the UE processor 174 are configured to process data and may be implemented in hardware or software executed by hardware. For example, the UE processor 174 may be an 8-bit, a 16-bit, a 32-bit, a 64-bit, or any other suitable architecture. The UE processor 174 comprises an ALU to perform arithmetic and logic operations, processor registers that supply operands to the ALU, and store the results of ALU operations, and a control unit that fetches software instructions such as the UE instructions 180 from the UE memory 178 and executes the UE instructions 180 by directing the coordinated operations of the ALU, registers, and other components via the UE processing engine 176. The UE processor 174 may be configured to execute various instructions. For example, the UE processor 174 may be configured to execute the UE instructions 180 to implement functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

### Radio Access Network

In one or more embodiments, the RAN 112 enables the user equipment 114 to access one or more services in the core network 110. The one or more services may be a mobile telephone service, a Short Message Service (SMS) message service, a Multimedia Message Service (MMS) message service, an Internet access, cloud computing, or other types of data services. The RAN 112 may comprise the base stations 160 in signal communication with the user equipment 114 via the one or more communication links 116. Each of the base stations 160 may service the user equipment 114. In some embodiments, while multiple base stations 160 are shown connected to multiple user equipment 114 via the communication link 116, one or more additional base stations 160 may be connected to one or more additional user equipment 114 via one or more additional communication links 116. For example, the base station 160a-110g may exchange connectivity signals with the user equipment 114a via the communication link 116a. In another example, the base station 160G may exchange connectivity signals with the user equipment 114g via the communication link 116g. In yet another example, the base stations 160 may service some user equipment 114 located within a geographic area serviced by one of the base stations 160.

In one or more embodiments, referring to the base station 160a as a non-limiting example of the base station 160, the base station 160a may comprise a base station (BS) network interface 182, a BS I/O interface 184, a BS processor 186, and a BS memory 188. The BS network interface 182 may be any suitable hardware or software (e.g., executed by hardware) to facilitate any suitable type of communication in wireless or wired connections between the core network 110 and the user equipment 114. These connections may comprise, but not be limited to, all or a portion of network connections coupled to additional network components 118 in the core network 110, other base stations 160, the user equipment 114, the Internet, an Intranet, a private network, a public network, a peer-to-peer network, the public switched telephone network, a cellular network, a LAN, a MAN, a WAN, and a satellite network. The BS network interface 182 may be configured to support any suitable type of communication protocol.

The BS I/O interface 184 may be hardware configured to perform one or more communication operations 302-336 described in process 300 in reference to FIG. 3. The BS I/O interface 184 may comprise one or more antennas as part of a transceiver, a receiver, or a transmitter for communicating using one or more wireless communication protocols or technologies. In some embodiments, the BS I/O interface 184 may be configured to communicate using, for example, 5G NR or LTE using at least some shared radio components. In other embodiments, the BS I/O interface 184 may be configured to communicate using single or shared RF bands. The RF bands may be coupled to a single antenna, or may be coupled to multiple antennas (e.g., for a MIMO configuration) to perform wireless communications. In some embodiments, the base station 160A may allocate resources in accordance with one or more routing and configuration operations obtained from the core network 110. In some embodiments, resources may be allocated to enable capabilities in the user equipment 114 for voice communication, mobile broadband services (e.g., video streaming, navigation, and the like), or other types of applications.

In some embodiments, the base station 160a is communicatively coupled to one or more of the user equipment 114 via the one or more communication links 116. In some applications, the base stations 160a may be referred to as BS, evolved Node B (eNodeB or eNB), a next generation Node B, gNodeB, gNB, or terminal.

The BS processor 186 may comprise one or more processors operably coupled to and in signal communication with the BS network interface 182, the BS I/O interface 184, and the BS memory 188. The BS processor 186 is any electronic circuitry, including, but not limited to, state machines, one or more CPU chips, logic units, cores (e.g., a multi-core processor), FPGAs, ASICs, or DSPs. The BS processor 186 may be a programmable logic device, a microcontroller, a microprocessor, or any suitable combination of the preceding. The one or more processors in the BS processor 186 are configured to process data and may be implemented in hardware or software executed by hardware. For example, the BS processor 186 may be an 8-bit, a 16-bit, a 32-bit, a 64-bit, or any other suitable architecture. The BS processor 186 comprises an ALU to perform arithmetic and logic operations, processor registers that supply operands to the ALU, and store the results of ALU operations, and a control unit that fetches software instructions (not shown) from the BS memory 188 and executes the software instructions by directing the coordinated operations of the ALU, registers, and other components via a processing engine (not shown) in the BS processor 186. The BS processor 186 may be configured to execute various instructions. For example, the BS processor 186 may be configured to execute the software instructions to implement functions or perform operations disclosed herein, such as some or all of those described with respect to FIGS. 1-3. In some embodiments, the functions described herein are implemented using logic units, FPGAs, ASICs, DSPs, or any other suitable hardware or electronic circuitry.

Core Network The core network 110 may be a network configured to manage communication sessions for the user equipment 114. In one or more embodiments, the core network 110 may establish connections between user equipment 114 and a particular data network 108 in accordance with one or more communication protocols. In the example of FIG. 1, the core network 110 comprises one or more network components configured to perform one or more NFs. In some embodiments, the core network 110 enables the user equipment 114 to communicate with the server 102, or another type of device, located in a particular data network 108 or in signal communication with a particular data network 108. The core network 110 may implement a communication method that does not require the establishment of a specific communication protocol connection between the user equipment 114 and one or more of the data networks 108. The core network 110 may include one or more types of network devices (not shown), which may perform different NFs.

In some embodiments, the core network 110 may include a 5G NR or an LTE access network (e.g., an evolved packet core (EPC) network) among others. In this regard, the core network 110 may comprise one or more logical networks implemented via wireless connections or wired connections. Each logical network may comprise an end-to-end virtual network with dedicated power, storage, or computation resources. Each logical network may be configured to perform a specific application comprising individual policies, rules, or priorities. Further, each logical network may be associated with a particular Quality of Service (QOS) class, type of service, or particular user associated with one or more of the user equipment 114. For example, a logical network may be a Mobile Private Network (MPN) configured for a particular organization. In this example, when the user equipment 114a is configured and activated by a wireless network associated with the RAN 112, the user equipment 114a may be configured to connect to one or more particular network slices (i.e., logical networks) in the core network 110. Any logical networks or slices that may be configured for the user equipment 114a may be configured using a network component (e.g., one of the network components 118 (e.g., the network component 118a, the network component 118b, and the network component 118g representing the network component 118a-118g) of FIG. 1.

In one or more embodiments, each of the network components 118 may comprise a component processor 192 configured to perform one or more similar operations to those described in reference to the BS processor 186 and the UE processor 174. In other embodiments, each of the network components 118 may comprise a component memory 194 configured to perform one or more similar operations to those described in reference to the BS memory 188 and the UE memory 178.

### Data Networks

In the example system 100 of FIG. 1, the data networks 108 may facilitate communication within the communication system 100. This disclosure contemplates that the data networks 108 may be any suitable network operable to facilitate communication between the server 102, the core network 110, the RAN 112, and the user equipment 114. The data networks 108 may include any interconnecting system capable of transmitting audio, video, signals, data, messages, or any combination of the preceding. The data networks 108 may include all or a portion of a LAN, a WAN, an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the communication system 100. In other embodiments, the communication system 100 may not have all of these components or may comprise other elements instead of, or in addition to, those above.

### System Architecture

FIG. 2 illustrates an example system architecture 200 for an open (O)-RAN logic architecture, in accordance with one or more embodiments. The system architecture 200 may comprise some, all, or any of the components performing the functions and/or as described in technical specification (TS) produced by working group 2 (WG2) of the O-RAN Alliance O-RAN.WG2.Non-RT-RIC-ARCH-R003-v05.00, TS produced by WG4 of the O-RAN Alliance O-RAN.WG4.MP.0-R003-v14.00, and/or 3GPP TR 21.905.

In one or more embodiments, the system architecture 200 comprises a service management and orchestration framework (SMO-F) 202 comprising a non-real time RIC 204, a near-real time RIC 206, an O-eNB 208, an operation (O)-control unit (CU)-control plane (CP) 210, an O-CU-user plane (UP) 212, an O-distributed unit (DU) 214, an O-radio unit (RU) 216, and an O-Cloud 218. The SMO-F 202 is communicatively coupled to the O-DU 214 and the O-RU 216 via an O1 interface, the O-RU 216 via an open fronthaul (FH)-management (M)-plane interface, the O-cloud via an O2 interface, and the O-eNB 208 via one or more O1 interfaces. The near-real time RIC 206 may be communicatively coupled to the O-eNB 208, the O-CU-CP 210, the O-CU-UP 212, and the O-DU via one or more E2 interfaces, the non-real time RIC 204 via an A1 interface, and the SMO-F 202, the O-CU-CP 210, and the O-CU-UP 212 via one or more O1 interfaces. The O-CU-CP 210 may be communicatively coupled to the O-DU 214 via an interface of the control plane of the F1 (F1-C interface). The O-CU-UP 212 may be communicatively coupled to the O-DU 214 via an interface of the user plane of the F1 (F1-U interface). The O-DU 214 may be communicatively coupled to the O-RU 216 via an open FH control user synchronization (CUS)-plane and an open FH M-plane. The O-CU-CP 210 may be communicatively coupled to the O-CU-UP 212 via an E1 interface. The O-CU-CP 210 and/or the O-CU-UP 212 may be configured to communicate using multiple additional interfaces. In FIG. 2, these interfaces comprise an X2-c interface, an X2-u interface, an NG-u interface, an Xn-u interface, an Xn-c interface, and an NG-c interface. The non-real time RIC 204 and the near-real time RIC 206 may share a non-RT RIC framework. The non-real time RIC 204 may comprise one or more non-real time network automation applications (rAPPs). In some embodiments, the non-real time RIC 204 and/or the near-real time RIC 206 may be configured to perform one or more of the scaling operations 103 performed by the server 102. The near-real time RIC 206 may comprise one or more near-real time network automation applications (xAPPs).

In one or more embodiments, the near-real time RIC 206 may be an intelligent controller configured to perform one or more logical operations that enable near-real-time control and optimization of O-RAN elements and resources via fine-grained data collection and actions over the E2 interface. The non-real-time RIC 204 may be an intelligent controller configured to perform one or more logical operations that enable non-real-time control and optimization of RAN elements and resources, workflow associated with artificial intelligence and/or machine learning (ML) elements including model training, updates, and policy-based guidance of applications, features, and/or services. The O-CU may be a logical node hosting radio resource control (RRC), service data adaptation protocol (SDAP), and packet data convergence protocol (PDCP) protocols. The O-CU-CP 210 may be a logical node hosting RRC and control plane portions of the PDCP protocols. The O-CU-UP 212 may be a logical node hosting user plane portions of the PDCP protocol and the SDAP protocol. The O-DU 214 may be a logical node hosting radio link control (RLC) elements, medium access control (MAC) elements, and/or physical (PHY) layer elements (e.g., the layers themselves) based on a lower layer functional split. The O-RU 216 may be a logical node hosting PHY layer elements and radiofrequency (RF) processing based on a lower layer functional split.

In some embodiments, the one or more O1 interfaces may be connection interfaces between management entities in the SMO-F 202 and O-RAN managed elements. The one or more xAPPs may be independent service plug-ins to the near-real time RIC 206 platform to provide operations extensibility to the RAN by third parties. The one or more E2 interfaces may be open interfaces between two end points (e.g., the near-real time RIC 206 and network elements associated with one or more E2 interfaces (e.g., distributed units (Dus), central units (CUs), and the like). In some embodiments, the one or more E2 interfaces are configured to allow the non-real time RIC 204 to control procedures and functionalities of network elements associated with one or more E2 interfaces (e.g., E2 nodes). The one or more F1 interfaces may be configured to connect a gNB CU to a gNB DU. The one or more F1 interfaces may be associated with CU and DU splits in gNB architecture. The control plane of the F1 (F1-C) may allow signaling between the CU and DU, while the user plane of the F1 (F1-U) may allow the transfer of application data.

The open fronthaul interface may be configured to connect the O-DU 214 and the O-RU 216. Herein, the open fronthaul interface may comprise a management plane (M-Plane) and a control user synchronization plane (CUS-Plane). The M-Plane may be configured to connect the O-RU to the O-DU and/or the O-RU to the SMO-F 202. The one or more A1 interfaces may enable communication between the non-real time RIC 204 and the near-real time RIC 206. Further, the A1 interfaces may be configured to support policy management, data transfer, and ML management. The one or more O1 interfaces may be configured to connect the SMO-F 202 to one or more RAN-managed elements. These RAN-managed elements comprise the near-real time RIC 206, the O-CU, the O-DU, the O-RU, and the O-eNB. In some embodiments, management and orchestration operations may be received by the managed elements via the O1 interface. The SMO-F 202 in turn may receive data from the managed elements via the one or more O1 interfaces for AI model training. The one or more O2 interfaces may be pathways to communicate between the SMO-F with the O-Cloud 218. In one or more embodiments, network operators that are connected to the O-Cloud 218 may then operate and maintain in a wireless O-RAN communication network (e.g., a communication network) with the one or more O1 interfaces or the one or more O2 interfaces by reconfiguring network elements, updating the system 100, or upgrading the system 100. The one or more X2 interfaces may comprise the X2-c interfaces and the X2-u interfaces. The X2-u interfaces may be configured to enable operations associated with the control plane. The X2-c interfaces may be configured to enable operations associated with the user plane. The Xn interfaces may comprise a control subtype labeled Xn-c and a user subtype labeled Xn-u. The NG interfaces may comprise a control subtype labeled NG-c and a user subtype labeled NG-u.

### Example On-Demand Scaling Operations

FIG. 3 illustrate an example flowchart of the process 300 to perform one or more on-demand scaling operations 103, in accordance with one or more embodiments. Modifications, additions, or omissions may be made to the process 300. The process 300 may include more, fewer, or other operations than those shown above. For example, operations may be performed in parallel or in any suitable order. While at times discussed as the server 102, one or more of the network components 118, one or more of the base stations 160, components of any of thereof, or any suitable system or components of the security system 100 may perform one or more operations of the process 300. For example, one or more operations of the process 300 may be implemented, at least in part, in the form of server instructions 132 of FIG. 1, stored on non-transitory, tangible, machine-readable media (e.g., server memory 130 of FIG. 1 operating as a non-transitory computer-readable medium) that when run by one or more processors (e.g., the server processor 122 of FIG. 1) may cause the one or more processors to perform operations described in operations 302-336.

In one or more embodiments, the server 102, the non-real time RIC 204, and/or the near-real time RIC 206 may be configured to modify one or more network resources in the virtual containers 104 and/or the virtual containers 104 in the one or more containerized environments 105. The server 102, the non-real time RIC 204, and/or the near-real time RIC 206 may be configured to increase performance in cloud deployments. The server 102, the non-real time RIC 204, and/or the near-real time RIC 206 may be configured to reallocate and/or reassign network resources and/or virtual containers in one or more containerized environments 105 in the O-RAN network. In some embodiments, the server 102, the non-real time RIC 204, and/or the near-real time RIC 206 may be configured to terminate unused network resources when certain network resources are not in use and add one or more network resources to meet the one or more resource demands 134.

In one or more embodiments, the process 300 comprises one or more operations configured to increase performance of CUs and Dus. In some embodiments, the process 300 may be configured to deploy CUs and DUs in a wireless O-RAN communication network. Herein, the server 102, the non-real time RIC 204, and/or the near-real time RIC 206 may be configured to leverage one or more autoscaling services to facilitate adding and/or reducing a number of virtual containers 104 in the one or more containerized environments 105. The server 102, the non-real time RIC 204, and/or the near-real time RIC 206 may be configured to regularly update the alarm inputs 148 and/or the tracked indicators 150 based on the resource demands 134 requested in the communication system 100 for the DUs and CUs. The tracked indicators 150 may comprise key parameter indicator (KPI) thresholds that are set for a processing load and/or a number of users/communication operations in a given CU and/or DU. Each alarm input 148 may be provided to an alarm service (e.g., CloudWatch) and an alarm input 148 may be set if one or more communication conditions 154 are met. The alarm inputs 148 and the tracked indicators 150 may be be stored in the server memory 130 to be retrieved through APIs. In some embodiments, the server 102, the non-real time RIC 204, and/or the near-real time RIC 206 may be configured to generate one or more possible modifications 144 in response to triggering one or more of the alarm inputs 148. The alarm inputs 148 may be triggered based on determining that one or more of the tracked indicators 150 are met within a period of time (e.g., a time duration). In some embodiments, as soon as the server 102, the non-real time RIC 204, and/or the near-real time RIC 206 reads a given alarm input 148 and/or one or more tracked indicators 150 through a given API, the server 102, the non-real time RIC 204, and/or the near-real time RIC 206 may be configured to start triggering one or more modifications and/or changes to the network resource utilization in the virtual containers 104 in the one or more containerized environments 105. The server 102, the non-real time RIC 204, and/or the near-real time RIC 206 may be configured to iteratively evaluate resource demands 134 continuously and/or periodically over time. The continuous feedback to the server 102, the non-real time RIC 204, and/or the near-real time RIC 206 may be configured to maintain and/or achieve optimum number of virtual containers 104 in one or more containerized environments 105 via one or more scaling operations 103 and thus achieve target performance and cost.

The process 300 starts at operation 302, where the server 102 is configured to determine a network resource demand 134 in a communication network (e.g., in a wireless O-RAN communication network). The network resource demand 134 may be configured to comprise one or more resource assignments in the communication network.

The process 300 continues at operation 310, where the server 102 is configured to determine whether the network resource demand 134 meets a usage threshold 152 (e.g., one or more of the tracked indicators 150). In some embodiments, determining that the tracked indicators 150 are met comprise determining whether the network resource demand 134 is equal to or greater than a specific usage threshold 152. In other embodiments, determining that the tracked indicators 150 are met comprise determining whether the network resource demand 134 is equal to or less than a specific usage threshold 152. In response, if the server 102 determines that the network resource demand 134 does not meet a usage threshold 152 (i.e., NO), the process 300 proceeds to operation 322. In this case, the process 300 may conclude at operation 322, the server 102 is configured to generate a report 146 indicating that the network resource demand 134 is met using current configuration of the communication network. If the server 102 determines that the network resource demand 134 meets the usage threshold 152 (i.e., YES), the process 300 proceeds to operation 332. At operation 332, the server 102 is configured to generate a trigger requesting rescaling of one or more virtual containers 104 in one or more containerized environments 105 associated with the communication network. In response to determining that the network resource demand 134 meets the usage threshold 152, the server 102, the non-real time RIC 204, and/or the near-real time RIC 206 may be configured to generate one or more triggers requesting rescaling of one or more virtual containers 104 in the one or more containerized environments 105.

The process 300 may conclude at operations 334 and 336, where the server 102 is configured to trigger modification and/or changes to a current network resource utilization. At operation 334, the server 102 is configured to generate multiple possible modifications 144 based on the one or more triggers. The possible modifications 144 may be configured to comprise one or more changes to network resource utilization in the communication network. At operation 336, the server 102 is configured to rescale the one or more virtual containers 104 in the one or more containerized environments 105 in accordance with the possible modifications 144.

In one or more embodiments, in conjunction with rescaling the one or more virtual containers 104, the server 102, the non-real time RIC 204, and/or the near-real time RIC 206 may be configured to increase a number of the one or more virtual containers 104 in the one or more containerized environments 105. Further, in conjunction with rescaling the one or more virtual containers 104, the server 102, the non-real time RIC 204, and/or the near-real time RIC 206 may be configured to decrease a number of the one or more virtual containers 104 in the one or more containerized environments 105. In some embodiments, the resource assignments in the communication network may correspond to a change in a number of CUs to be provisioned in the communication network. In other embodiments, the resource assignments in the communication network may correspond to a change in a number of DUs to be provisioned in the communication network. The resource assignments in the communication network may correspond to a change in one or more KPIs (e.g., the tracked indicators 150) tracking performance of the one or more virtual containers 104 in the one or more containerized environments 105. The one or more usage thresholds 152 may be updated dynamically over time. The one or more usage thresholds 152 are updated periodically over time.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
one or more usage thresholds associated with demand usage in a communication network; and
a processor communicatively coupled to the memory and configured to:
determine a first network resource demand in the communication network, the first network resource demand comprising a first plurality of resource assignments in the communication network;
determine whether the first network resource demand meets a first usage threshold;
in response to determining that the first network resource demand meets the first usage threshold, generate a first trigger requesting rescaling of one or more virtual containers in a containerized environment associated with the communication network;
generate a first plurality of possible modifications based on the first trigger, the first plurality of possible modifications comprising one or more changes to network resource utilization in the communication network; and
rescale the one or more virtual containers in the containerized environment in accordance with the first plurality of possible modifications.

2. The apparatus of claim 1, wherein the processor is further configured to:
determine a second network resource demand in the communication network, the second network resource demand comprising a second plurality of resource assignments in the communication network;
determine whether the second network resource demand is greater than a second usage threshold;
in response to determining that the second network resource demand is greater than the second usage threshold, generate a second trigger requesting rescaling of the one or more virtual containers in the containerized environment associated with the communication network;
generate a second plurality of possible modifications based on the second trigger, the second plurality of possible modifications comprising one or more additional changes to the network resource utilization in the communication network;
rescale the one or more virtual containers in the containerized environment in accordance with the second plurality of possible modifications; and
in conjunction with rescaling the one or more virtual containers, increase a number of the one or more virtual containers in the containerized environment.

3. The apparatus of claim 1, wherein the processor is further configured to:
determine a second network resource demand in the communication network, the second network resource demand comprising a second plurality of resource assignments in the communication network;
determine whether the second network resource demand is less than a second usage threshold;
in response to determining that the second network resource demand is less than the second usage threshold, generate a second trigger requesting rescaling of the one or more virtual containers in the containerized environment associated with the communication network;
generate a second plurality of possible modifications based on the second trigger, the second plurality of possible modifications comprising one or more additional changes to the network resource utilization in the communication network;
rescale the one or more virtual containers in the containerized environment in accordance with the second plurality of possible modifications; and
in conjunction with rescaling the one or more virtual containers, decrease a number of the one or more virtual containers in the containerized environment.

4. The apparatus of claim 1, wherein:
the first plurality of resource assignments in the communication network correspond to a change in a number of Central Units (CUs) to be provisioned in the communication network.

5. The apparatus of claim 1, wherein:
the first plurality of resource assignments in the communication network correspond to a change in a number of Distributed Units (DUs) to be provisioned in the communication network.

6. The apparatus of claim 1, wherein:
the first plurality of resource assignments in the communication network correspond to a change in one or more key performance indicators (KPIs) tracking performance of the one or more virtual containers the containerized environment.

7. The apparatus of claim 1, wherein the one or more usage thresholds are updated dynamically over time.

8. The apparatus of claim 1, wherein the one or more usage thresholds are updated periodically over time.

9. A method, comprising:
determining a first network resource demand in a communication network, the first network resource demand comprising a first plurality of resource assignments in the communication network;
determining whether the first network resource demand meets a first usage threshold;
in response to determining that the first network resource demand meets the first usage threshold, generating a first trigger requesting rescaling of one or more virtual containers in a containerized environment associated with the communication network;
generating a first plurality of possible modifications based on the first trigger, the first plurality of possible modifications comprising one or more changes to network resource utilization in the communication network; and
rescaling the one or more virtual containers in the containerized environment in accordance with the first plurality of possible modifications.

10. The method of claim 9, further comprising:
determining a second network resource demand in the communication network, the second network resource demand comprising a second plurality of resource assignments in the communication network;
determining whether the second network resource demand is greater than a second usage threshold;
in response to determining that the second network resource demand is greater than the second usage threshold, generating a second trigger requesting rescaling of the one or more virtual containers in the containerized environment associated with the communication network;
generating a second plurality of possible modifications based on the second trigger, the second plurality of possible modifications comprising one or more additional changes to the network resource utilization in the communication network;
rescaling the one or more virtual containers in the containerized environment in accordance with the second plurality of possible modifications; and
in conjunction with rescaling the one or more virtual containers, increasing a number of the one or more virtual containers in the containerized environment.

11. The method of claim 9, further comprising:
determining a second network resource demand in the communication network, the second network resource demand comprising a second plurality of resource assignments in the communication network;
determining whether the second network resource demand is less than a second usage threshold;
in response to determining that the second network resource demand is less than the second usage threshold, generating a second trigger requesting rescaling of the one or more virtual containers in the containerized environment associated with the communication 10 network;
generating a second plurality of possible modifications based on the second trigger, the second plurality of possible modifications comprising one or more additional changes to the network resource utilization in the communication network;
rescaling the one or more virtual containers in the containerized environment in accordance with the second plurality of possible modifications; and
in conjunction with rescaling the one or more virtual containers, decreasing a number of the one or more virtual containers in the containerized environment.

12. The method of claim 9, wherein:
the first plurality of resource assignments in the communication network correspond to a change in a number of Central Units (CUs) to be provisioned in the communication network.

13. The method of claim 9, wherein:
the first plurality of resource assignments in the communication network correspond to a change in a number of Distributed Units (DUs) to be provisioned in the communication network.

14. The method of claim 9, wherein:
the first plurality of resource assignments in the communication network correspond to a change in one or more key performance indicators (KPIs) tracking performance of the one or more virtual containers the containerized environment.

15. The method of claim 14, wherein the first usage threshold is updated dynamically over time.

16. A non-transitory computer-readable medium storing instructions that when executed by a processor cause the processor to:
determine a first network resource demand in a communication network, the first network resource demand comprising a first plurality of resource assignments in the communication network;
determine whether the first network resource demand meets a first usage threshold;
in response to determining that the first network resource demand meets the first usage threshold, generating a first trigger requesting rescaling of one or more virtual containers in a containerized environment associated with the communication network;
generate a first plurality of possible modifications based on the first trigger, the first plurality of possible modifications comprising one or more changes to network resource utilization in the communication network; and
rescale the one or more virtual containers in the containerized environment in accordance with the first plurality of possible modifications.

17. The non-transitory computer-readable medium of claim 16, wherein the instructions further cause the processor to:
determine a second network resource demand in the communication network, the second network resource demand comprising a second plurality of resource assignments in the communication network;
determine whether the second network resource demand is greater than a second usage threshold;
in response to determining that the second network resource demand is greater than the second usage threshold, generate a second trigger requesting rescaling of the one or more virtual containers in the containerized environment associated with the communication network;
generate a second plurality of possible modifications based on the second trigger, the second plurality of possible modifications comprising one or more additional changes to the network resource utilization in the communication network;
rescale the one or more virtual containers in the containerized environment in accordance with the second plurality of possible modifications; and
in conjunction with rescaling the one or more virtual containers, increase a number of the one or more virtual containers in the containerized environment.

18. The non-transitory computer-readable medium of claim 16, wherein the instructions further cause the processor to:
determine a second network resource demand in the communication network, the second network resource demand comprising a second plurality of resource assignments in the communication network;
determine whether the second network resource demand is less than a second usage threshold;
in response to determining that the second network resource demand is less than the second usage threshold, generate a second trigger requesting rescaling of the one or more virtual containers in the containerized environment associated with the communication network;
generate a second plurality of possible modifications based on the second trigger, the second plurality of possible modifications comprising one or more additional changes to the network resource utilization in the communication network;
rescale the one or more virtual containers in the containerized environment in accordance with the second plurality of possible modifications; and
in conjunction with rescaling the one or more virtual containers, decrease a number of the one or more virtual containers in the containerized environment.

19. The non-transitory computer-readable medium of claim 16, wherein:
the first plurality of resource assignments in the communication network correspond to a change in a number of Central Units (CUs) to be provisioned in the communication network.

20. The non-transitory computer-readable medium of claim 16, wherein the instructions further cause the processor to:
the first plurality of resource assignments in the communication network correspond to a change in a number of Distributed Units (DUs) to be provisioned in the communication network.
